(19) United States
(12) Patent Application Publication
(10) Pub. No.: US 2015/0353403 A1
(43) Pub. Date: Dec. 10, 2015

(54) GREEN HOUSE FOR TREATMENT OF SLUDGE

(71) Applicant: Gary V. Hammond, Leesburg, FL (US)

(72) Inventor: Gary V. Hammond, Leesburg, FL (US)

(21) Appl. No.: 14/298,468

(22) Filed: Jun. 6, 2014

(51) Int. Cl. C02F 11/12

(52) U.S. Cl. CPC C02F 11/12; C02F 11/121; C02F 2303/02; C02F 2201/002

(57) ABSTRACT

The present invention includes a green house for turning sludge into biosolids. The green house includes a base and at least one sidewall protruding from the base forming a receptacle in between. The receptacle is formed to secure sludge within. At least a portion of the sidewall is transparent. The present invention may further include a transparent top covering the receptacle. A mirrored surface may be within the receptacle and facing towards the receptacle to increase the reflection of light and thereby the heat within the green house.

### BACKGROUND OF THE INVENTION

The present invention relates to the treatment of sludge and, more particularly, to a green house utilizing mirrors for the treatment of sludge.

Sewage sludge is produced from the treatment of wastewater and consists of two basic forms: raw primary sludge (fecal matter); and secondary sludge (a living ‘culture’ of organisms that help remove contaminants from wastewater before it is returned to rivers or the sea). The sludge is transformed into biosolids using a number of complex treatments such as digestion, thickening, dewatering, drying, and lime/alkaline stabilization. Treating the sludge as efficiently and effectively as possible is desired to save time, money and space.

As can be seen, there is a need for more effective and efficient systems of treating sludge.

### SUMMARY OF THE INVENTION

In one aspect of the present invention, a green house comprises: a base; at least one sidewall protruding from the base forming a receptacle in between formed to secure sludge within; a transparent top covering the receptacle; and a mirrored surface within the receptacle and facing towards the receptacle.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a side elevation view of the embodiment of FIG. 1; and

FIG. 3 is a top plan view of the embodiment of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a greenhouse with mirrors, such as steel mirrors, on the North wall to reflect more sunlight on sludge. The present invention may speed up the drying of biosolids (sludge) from Wastewater treatment plants. By adding mirrors to the back side of a greenhouse more sunlight is sent to the floor of the greenhouse and the biosolids dry faster. Sunlight comes through the clear greenhouse roof and from a south wall. The sunlight then hits the drying bed floor or hits the steel mirror and is reflected to the floor of the drying bed. The present invention thereby removes moisture from the biosolids. The present invention may decrease the amount of cubic feet of biosolids needed for disposal or further processing.

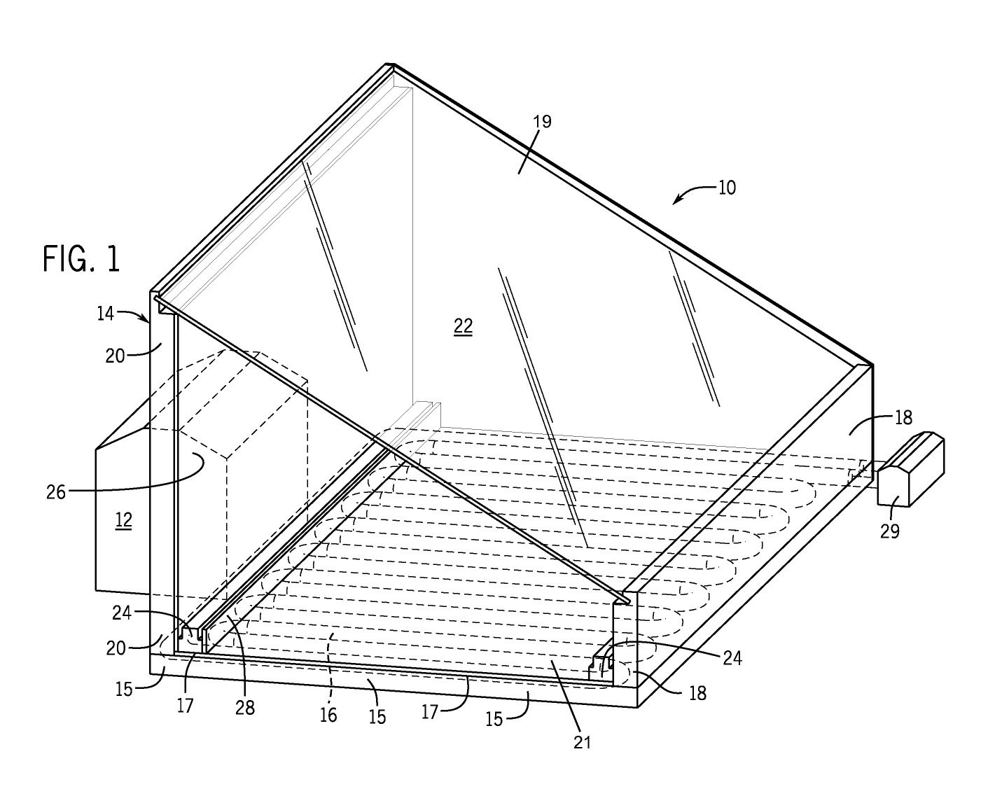

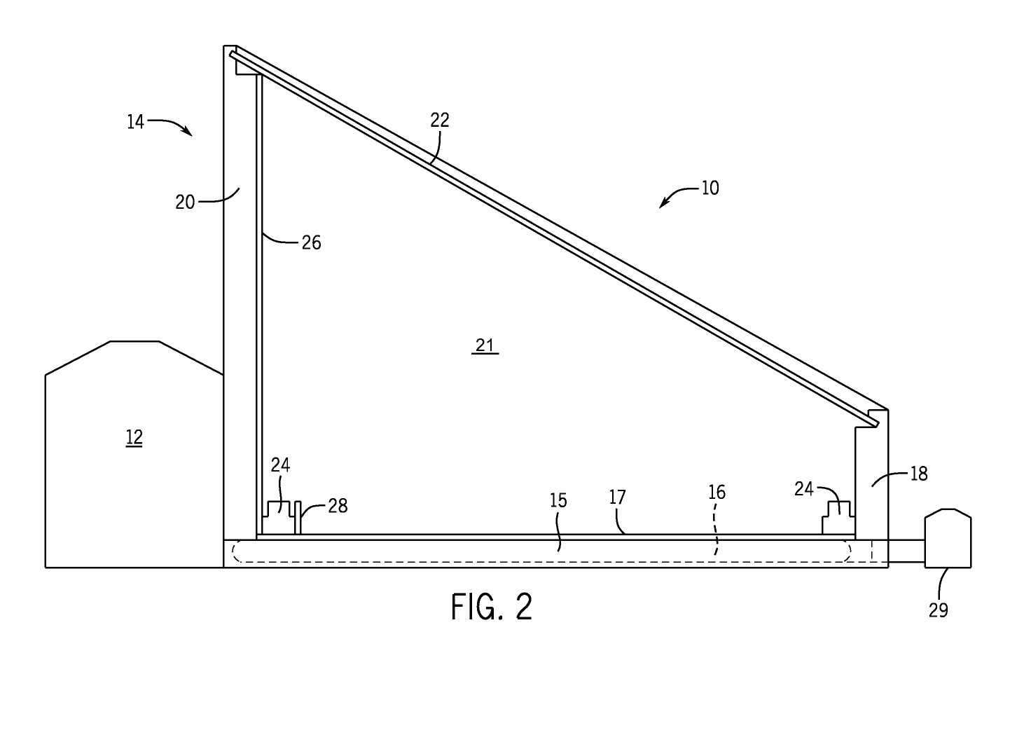

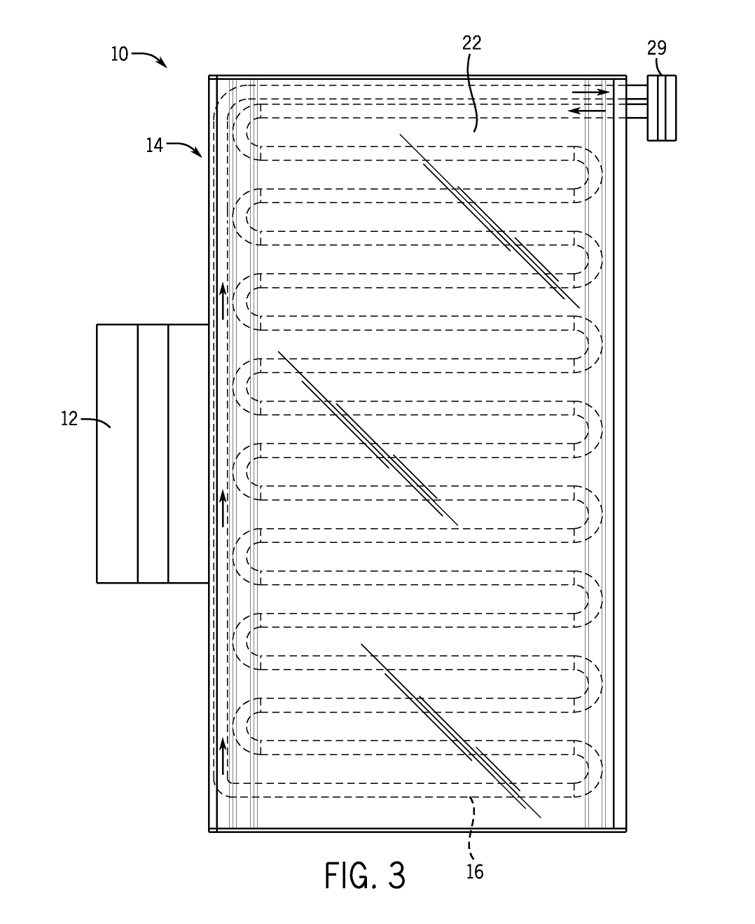

Referring to FIGS. 1 through 3, the present invention includes a green house 10 for turning sludge into biosolids. The green house 10 includes a base 15 and at least one sidewall 14 protruding from the base 15 forming a receptacle in between. The receptacle is formed to secure sludge within. At least a portion of the sidewall 14 is transparent. The present invention may further include a transparent top 22 covering the receptacle. A mirrored surface 26 may be within the receptacle and facing towards the receptacle to increase the heat within the green house 10 and therefore dry the sludge at a faster rate.

In certain embodiments, the at least one sidewall 14 may include four sidewalls 14. For example, the four sidewalls 14 may include a front wall 18, a rear wall 20, a first wall 19 and a second wall 21. The four sidewalls 14 may form a parallelogram. In certain embodiments, the front wall 18, the first wall 19 and the second wall 21 are substantially transparent. The rear wall 20 may include the mirrored surface 26. In certain embodiments, the mirrored surface 26 may be attached to the North end of the sidewall 14. Therefore, the rear wall 20 may be the North end of the greenhouse 10.

In certain embodiments, the rear wall 20 may have a greater height than the front wall 18. The first wall 19 and the second wall 21 are connected to both the rear wall 20 and the front wall 18, and may thereby taper downward from the rear wall 20 to the front wall 18. The transparent top 22 may be attached to the top rim of the sidewalls 14. Therefore, the transparent top 22 is disposed at an angle relative to the base 15. In certain embodiments, the rear wall 20 may be positioned at an angle towards the base 15, and thereby reflect more light onto the sludge.

The base 15 of the present invention may be made of concrete, or any appropriate material. A steel plate 17 may cover the concrete base 15. In certain embodiments, a piping 16 may be embedded within the concrete. The piping 16 may be connected to a circulator 29. The circulator 29 may pump hot air or water though the piping 16 to heat the base 15. Such embodiments may be used to speed up the process of drying the sludge. For example, in colder climates, the additional heat added to the base 15 may significantly aid in the process of treatment.

The present invention may further include a bio-filter 12. The bio-filter 12 may be operatively connected through the sidewall 14 and into the receptacle. The bio-filter 12 may contain wood chips. A vacuum or fan may remove air from the receptacle and blow the air into the bio-filter 12. The bio-filter 12 may remove the odor of the sludge during treatment.

In certain embodiments, the present invention may include a plurality of tracks 24 running along at least a portion of the inner perimeter of the receptacle. In certain embodiments, the tracks 24 may also include a second mirrored surface 28 to further add reflection of light within the receptacle. The tracks 24 may be used to receive a Fresnel panel frame including Fresnel panels. The Fresnel panels may be used to magnify the light and further heat the sludge.

It should be understood, of course, that the foregoing relates to exemplary embodiments of the invention and that modifications may be made without departing from the spirit and scope of the invention as set forth in the following claims.

What is claimed is:

1. A green house comprising:
a base;
at least one sidewall protruding from the base forming a receptacle in between formed to secure sludge within;
a transparent top covering the receptacle; and
a mirrored surface within the receptacle and facing towards the receptacle.

2. The green house of claim 1, wherein at least a portion of the at least one sidewall is transparent.

3. The green house of claim 1, wherein the at least one sidewall comprises a front wall, a rear wall, a first wall and a second wall.

4. The green house of claim 2, wherein the front wall, the first wall and the second wall are substantially transparent, and the rear wall comprises the mirrored surface.

5. The green house of claim 3, wherein the rear wall comprises a greater height than the front wall, wherein the first wall and the second wall are tapered and the transparent top is disposed at an angle relative to the base.

6. The green house of claim 1, wherein the mirrored surface is attached to the North end of the at least one sidewall.

7. The green house of claim 1, wherein the base is concrete.

8. The green house of claim 1, further comprising piping embedded within the base and attached to a circulator pumping at least one of hot water and hot air through the piping.

9. The green house of claim 1, further comprising a bio-filter operatively connected through the at least one sidewall and into the receptacle.

10. The green house of claim 1, further comprising a plurality of tracks running along at least a portion of the inner perimeter of the receptacle and configured to receive a Fresnel panel.
